(19) United States
(12) Patent Application Publication
(10) Pub. No.: US 2025/0303347 A1
(43) Pub. Date: Oct. 2, 2025

(54) CARBON DIOXIDE RECOVERY DEVICE

(71) Applicant: HONDA MOTOR CO., LTD., Tokyo (JP)

(72) Inventors: Keisuke SHIMIZU, Saitama (JP); Subaru MATSUMOTO, Saitama (JP); Toshiyuki INABA, Saitama (JP)

(21) Appl. No.: 19/063,341

(22) Filed: Feb. 26, 2025

(30) Foreign Application Priority Data
Mar. 28, 2024 (JP) 2024-053176

(51) Int. Cl. B01D 53/04; B01D 53/26; C01B 32/50

(52) U.S. Cl. CPC B01D 53/0446; B01D 53/0438; B01D 53/265; C01B 32/50; B01D 2256/22; B01D 2257/504; B01D 2257/80; B01D 2258/06; B01D 2259/4009

(57) ABSTRACT

Provided is a carbon dioxide recovery device capable of highly efficiently recovering carbon dioxide. A carbon dioxide recovery device includes a reactor that includes an adsorbent inside and executes an adsorption process in which a gas containing carbon dioxide is drawn toward the adsorbent to adsorb carbon dioxide and a desorption process in which the adsorbent is heated under surrounding reduced pressure to desorb the carbon dioxide from the adsorbent, a carbon dioxide recovery pump that applies suction force inside the reactor to recover the carbon dioxide desorbed in the desorption process, a heat exchanger that cools a gas containing the carbon dioxide drawn by the carbon dioxide recovery pump and water vapor to perform gas-liquid separation, and a ballast pipe that returns at least part of the carbon dioxide after gas-liquid separation through the heat exchanger into the carbon dioxide recovery pump as ballast gas.

This application is based on and claims the benefit of priority from Japanese Patent Application No. 2024-053176, filed on 28 Mar. 2024, the content of which is incorporated herein by reference.

### BACKGROUND OF THE INVENTION

### Field of the Invention

The present invention relates to a carbon dioxide recovery device.

### Related Art

Technologies for extracting a predetermined component from gas have been conventionally known. This kind of technology is disclosed in, for example, Japanese Unexamined Patent Application, Publication No. H9-95679 and Japanese Unexamined Patent Application, Publication No. 2000-288331. Japanese Unexamined Patent Application, Publication No. H9-95679 relates to a technology for recovering hydrocarbons from gas. Japanese Unexamined Patent Application, Publication No. 2000-288331 relates to a technology for separating condensable gas and non-condensable gas from a mixed gas consisting of the condensable gas and the non-condensable gas and recovering the condensable gas.
Patent Document 1: Japanese Unexamined Patent Application, Publication No. H9-95679
Patent Document 2: Japanese Unexamined Patent Application, Publication No. 2000-288331

### SUMMARY OF THE INVENTION

In a carbon dioxide recovery device in which a gas such as air containing carbon dioxide is drawn into a reactor that holds an adsorbent to adsorb the carbon dioxide onto the adsorbent, and the carbon dioxide adsorbed onto the adsorbent is desorbed to recover the carbon dioxide, decompression is performed by a vacuum pump in the desorption process. It is common for moisture to be included in air and the like, and in a case where an adsorbent that adsorbs water along with carbon dioxide is used, not only carbon dioxide but also water are desorbed from the adsorbent in the desorption process. The water is re-pressurized after passing through the vacuum pump and recovered in liquid form. If carbon dioxide is mixed with water having turned into liquid form through the desorption process, the purity of carbon dioxide ultimately recovered potentially decreases.

The present invention is intended to provide a carbon dioxide recovery device capable of highly efficiently recovering carbon dioxide desorbed from an adsorbent.
(1) The present invention is a carbon dioxide recovery device (for example, carbon dioxide recovery device 1 to be described later) including a reactor (for example, reactor 11 to be described later) that includes an adsorbent (for example, adsorbent 12 to be described later) inside and executes an adsorption process in which a gas containing carbon dioxide is drawn toward the adsorbent to adsorb the carbon dioxide and a desorption process in which the adsorbent is heated under surrounding reduced pressure to desorb the carbon dioxide from the adsorbent, a carbon dioxide recovery pump (for example, carbon dioxide recovery pump 63 to be described later) that applies suction force inside the reactor to recover the carbon dioxide desorbed in the desorption process, a cooler (for example, heat exchanger 64 to be described later) that is disposed downstream of the carbon dioxide recovery pump and cools a gas containing the carbon dioxide drawn by the carbon dioxide recovery pump and water vapor to perform gas-liquid separation, and a ballast pipe (for example, ballast pipe 170 to be described later) that returns at least part of the carbon dioxide after gas-liquid separation through the cooler into the carbon dioxide recovery pump as ballast gas.
(2) In the carbon dioxide recovery device described above in (1), the carbon dioxide recovery pump may include a compression chamber (for example, compression chamber 151 to be described later) that executes a compression process in which the gas drawn from the reactor is returned to atmospheric pressure, and the ballast pipe may be connected to or downstream of the compression chamber inside the carbon dioxide recovery pump.
(3) In the carbon dioxide recovery device described above in (1) or (2), a flow path (for example, flow path 160 to be described later) of the cooler through which the gas passes may be sloped so that an outlet (for example, outlet 160b to be described later) is positioned lower than an inlet (for example, inlet 160a to be described later).
(4) The carbon dioxide recovery device described above in (1) or (2) may further include a heat-pump heat source device (for example, heat source device 81 to be described later) that heats a heating thermal medium supplied to the reactor and cools a cooling thermal medium supplied to the reactor, and a thermal medium that cools the cooler may be the cooling thermal medium or the heating thermal medium.

According to the present invention, it is possible to provide a carbon dioxide recovery device capable of highly efficiently recovering carbon dioxide desorbed from an adsorbent.

### BRIEF DESCRIPTION OF THE DRAWINGS

FIG. 1 is a schematic diagram illustrating a configuration related to gas flow in a carbon dioxide recovery device according to an embodiment of the present invention;

FIG. 2 is a schematic diagram illustrating a configuration related to liquid flow in the carbon dioxide recovery device according to the present embodiment;

FIG. 3 is a schematic diagram illustrating a configuration related to gas flow in a reactor of the carbon dioxide recovery device according to the present embodiment;

FIG. 4 is a schematic diagram illustrating a configuration related to liquid flow in the reactor of the carbon dioxide recovery device according to the present embodiment;

FIG. 5 is a schematic diagram illustrating the configuration of a heat source circuit of the carbon dioxide recovery device according to the present embodiment; and

FIG. 6 is a schematic diagram illustrating a configuration for introducing ballast gas with high carbon dioxide concentration into a carbon dioxide recovery pump in the carbon dioxide recovery device according to the present embodiment.

### DETAILED DESCRIPTION OF THE INVENTION

An embodiment of the present invention will be described below with reference to the accompanying drawings.

### <Entire Configuration>

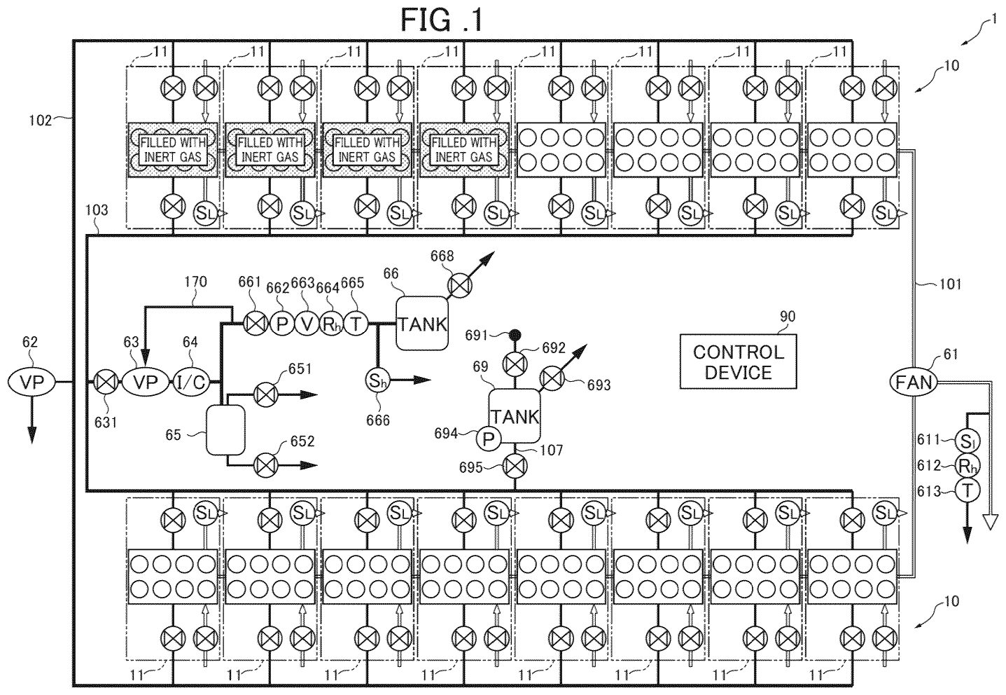

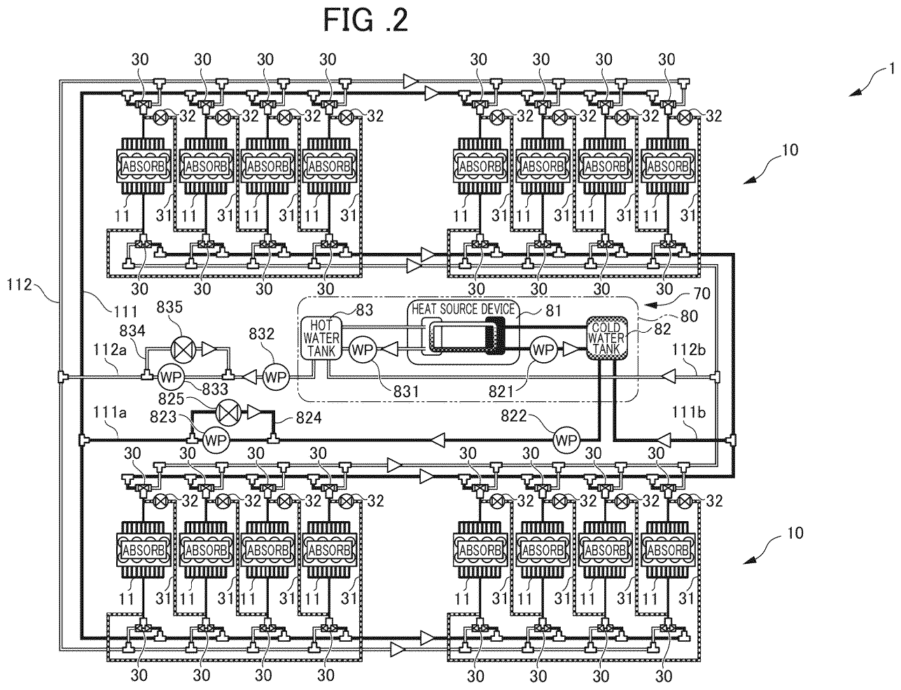

FIG. 1 is a schematic diagram illustrating a configuration related to gas flow in a carbon dioxide recovery device 1 according to the embodiment of the present invention. FIG. 2 is a schematic diagram illustrating a configuration related to liquid flow in the carbon dioxide recovery device 1 according to the present embodiment. Illustration of the configuration related to liquid flow in the carbon dioxide recovery device 1 is omitted in FIG. 1, and illustration of the configuration related to gas flow in the carbon dioxide recovery device 1 is omitted in FIG. 2.

The carbon dioxide recovery device 1 according to the present embodiment is applied to, for example, the Direct Air Capture technology (DAC), which recovers carbon dioxide in atmospheric air to lower the carbon dioxide concentration in the atmospheric air. Carbon dioxide recovered by the carbon dioxide recovery device 1 is stored underground or reused as fuel or material.

As illustrated in FIGS. 1 and 2, the carbon dioxide recovery device 1 according to the present embodiment includes a reactor unit 10, a fan 61, a vacuum pump 62, a carbon dioxide recovery pump 63, a heat exchanger 64, a separator 65, a carbon dioxide tank 66, an inert gas tank 69, a heat exchanger 70, and a control device 90.

As illustrated in FIG. 1, the carbon dioxide recovery device 1 includes an adsorption line 101, a vacuum line 102, a carbon dioxide line 103, a circulation line 104, and an inert gas supply line 107 as gas flow paths.

The reactor unit 10 has a configuration in which a plurality of reactors 11 that adsorb carbon dioxide are disposed in parallel. In the present embodiment, 16 reactors 11 in total are disposed in a pair of right and left reactor units 10.

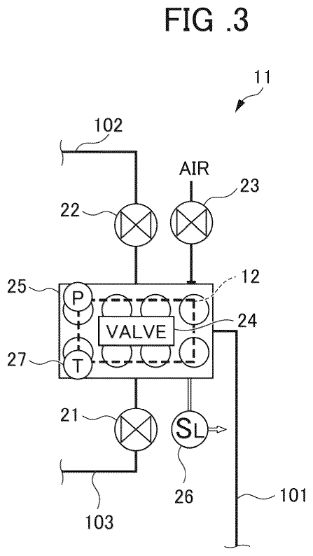

FIG. 3 is a schematic diagram illustrating a configuration related to gas flow in each reactor 11 of the carbon dioxide recovery device 1 according to the present embodiment. The reactor 11 is a carbon dioxide recovery reactor including an adsorbent 12, a first valve 21, a second valve 22, a third valve 23, a fourth valve 24, a pressure sensor 25, a carbon dioxide sensor 26, and a temperature sensor 27.

The adsorbent 12 is disposed inside the reactor 11 to adsorb carbon dioxide. The adsorbent 12 is a particulate member and has characteristics that it adsorbs carbon dioxide at low temperature (for example, −30° C. to 50° C.) and desorbs (releases) carbon dioxide at high temperature (for example, 50° C. to 110° C.) and low carbon dioxide concentration in surroundings. Such an adsorbent 12 is, for example, a solid amine carbon dioxide adsorbent composed of a porous material such as silica onto which amines are supported.

The first valve 21 is an on-off valve disposed at a connection part of the carbon dioxide line 103, which recovers carbon dioxide, to the reactor 11. The carbon dioxide recovery pump 63 is disposed in the carbon dioxide line 103. The second valve 22 is an on-off valve disposed at a connection part of the vacuum line 102, in which the vacuum pump 62 is disposed, to the reactor 11. The third valve 23 is an on-off valve disposed at an inlet through which atmospheric air and the like are taken into the reactor 11. The fourth valve 24 is an on-off valve disposed at a connection part of the adsorption line 101 to the reactor 11.

Opening and closing of the first valve 21, the second valve 22, the third valve 23, and the fourth valve 24 is controlled by the control device 90. The first valve 21, the second valve 22, the third valve 23, and the fourth valve 24 are constituted by, for example, normally-open butterfly valves.

The pressure sensor 25 measures the internal pressure of the reactor 11. The carbon dioxide sensor 26 measures the internal carbon dioxide concentration of the reactor 11. The temperature sensor 27 measures the temperature of the adsorbent 12. Measurement information of the pressure sensor 25, the carbon dioxide sensor 26, and the temperature sensor 27 are transmitted to the control device 90.

The adsorption line 101 and the fan 61 will be described below with reference to FIG. 1 again. The adsorption line 101 is branch-connected to each reactor 11. The fan 61 is disposed at a convergence part of branch parts of the adsorption line 101. When driven, the fan 61 generates gas flow from “intake” to “exhaust” in each reactor 11 through the adsorption line 101. Accordingly, atmospheric air is supplied into each reactor 11. A carbon dioxide concentration sensor 611, a humidity sensor 612, and a temperature sensor 613 are disposed at a part of the adsorption line 101, where gas is exhausted, to measure carbon dioxide exhausted from the adsorption line 101, humidity, and temperature. Measurement information of the carbon dioxide concentration sensor 611, the humidity sensor 612, and the temperature sensor 613 is transmitted to the control device 90.

The vacuum line 102 is branch-connected to each reactor 11. The vacuum pump 62 is disposed at a convergence part of branch parts of the vacuum line 102. When driven, the vacuum pump 62 draws in gas from inside each reactor 11 through the vacuum line 102 to bring the inside of the reactor 11 to a vacuum state or near-vacuum state.

The carbon dioxide line 103 is branch-connected to each reactor 11. The carbon dioxide recovery pump 63, the heat exchanger 64, the separator 65, and the carbon dioxide tank 66 are disposed at a convergence part of branch parts of the carbon dioxide line 103.

The carbon dioxide recovery pump 63 applies suction force that transfers carbon dioxide flowing through the carbon dioxide line 103 to the carbon dioxide tank 66. A one-way valve 631 is disposed upstream of the carbon dioxide recovery pump 63 in the carbon dioxide line 103. This configuration prevents gas backflow from the heat exchanger 64 side to the reactor 11 side.

The heat exchanger 64 is an intermediate cooler that cools a high-temperature gas containing carbon dioxide, which is recovered from the reactors 11, to perform gas-liquid separation.

Water subjected to gas-liquid separation through the heat exchanger 64 is recovered by the separator 65. A first valve 651 and a second valve 652 are disposed in the separator 65. The first valve 651 opens and closes a path communicating with a gas phase section of the separator 65. The second valve 652 opens and closes a path communicating with a liquid phase section of the separator 65.

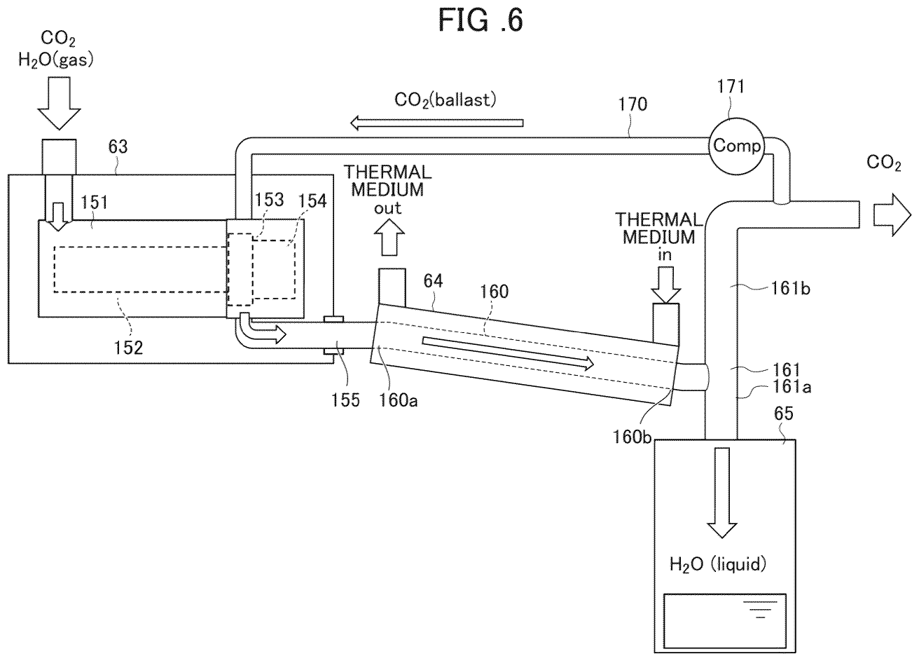

In the present embodiment, a ballast pipe 170 for introducing gas with high carbon dioxide concentration after subjected to gas-liquid separation through the heat exchanger 64 to the carbon dioxide recovery pump 63 as ballast gas is connected halfway through the carbon dioxide line 103. A configuration for introducing ballast gas to the carbon dioxide recovery pump 63 will be described later in detail with reference to FIG. 6.

The carbon dioxide tank 66 stores carbon dioxide recovered through the carbon dioxide line 103. A tank valve 661 is disposed upstream of the carbon dioxide tank 66 in the carbon dioxide line 103. Opening and closing of the tank valve 661 is controlled by the control device 90. Various sensors such as a pressure sensor 662, a flow rate sensor 663, a humidity sensor 664, a temperature sensor 665, and a carbon dioxide concentration sensor 666 are disposed between the tank valve 661 and the carbon dioxide tank 66 in the carbon dioxide line 103. In addition, a pressure relief valve 668 that releases pressure when the pressure becomes equal to or higher than a predetermined pressure is disposed at the carbon dioxide tank 66.

The inert gas tank 69 will be described next. The inert gas tank 69 stores N₂ as inert gas supplied from a N₂ gas tank 691 at a certain pressure or higher (for example, 980 kPa). A gas tank valve 692 is disposed between the inert gas tank 69 and the N₂ gas tank 691. In addition, a pressure relief valve 693 that releases pressure when the pressure becomes equal to or higher than a predetermined pressure is disposed at the inert gas tank 69. A pressure sensor 694 is disposed inside the inert gas tank 69. Pressure information measured by the pressure sensor 694 is transmitted to the control device 90.

The inert gas tank 69 is connected to the carbon dioxide line 103 through the inert gas supply line 107. An inert gas valve 695 is disposed in the inert gas supply line 107. Opening and closing of the inert gas valve 695 is controlled by the control device 90.

The heat exchanger 70 will be described below with reference to FIG. 2. The heat exchanger 70 supplies thermal energy for heating each reactor 11 of the reactor unit 10 to a predetermined temperature when the reactor 11 performs a desorption process. In addition, the heat exchanger 70 recovers unnecessary thermal energy when each reactor 11 performs an adsorption process.

The heat exchanger 70 according to the present embodiment includes a heat source circuit 80, a cold water line 111, a hot water line 112, three-way valves 30, bypass paths 31, and bypass valves 32.

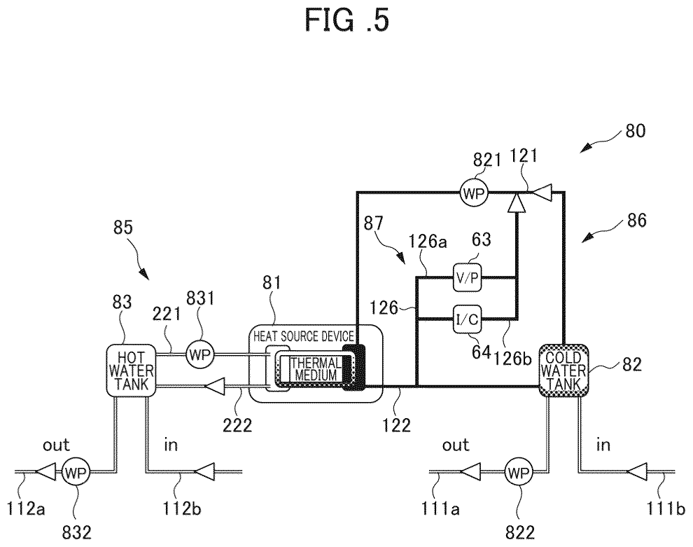

The heat source circuit 80 includes a heat source device 81, a cold water tank 82, and a hot water tank 83 as main components and performs heat exchange between a cooling thermal medium flowing through the cold water line 111 and a heating thermal medium flowing through the hot water line 112. With heat transfer that occurs in the heat source circuit 80, the thermal medium flowing through the cold water line 111 is cooled and the thermal medium flowing through the hot water line 112 is heated. A thermal medium is, for example, liquid such as water. A detailed configuration of the heat source circuit 80 will be described later with reference to FIG. 5.

The cold water line 111 is a pipe through which cold water as the cooling thermal medium flows. The cold water line 111 is branch-connected to the upstream and downstream sides of each reactor 11 to connect the cold water tank 82 and the reactor 11. In the cold water line 111, a line connected to the upstream side of the reactors 11 is referred to as a cold water supply line 111a, and a line connected to the downstream side of the reactors 11 is referred to as a cold water return line 111b.

The cold water supply line 111a is connected in parallel to the reactors 11 and can perform cold water supply to the reactors 11 in parallel. A first cold water circulation water pump 822 and a second cold water circulation water pump 823 are disposed in the cold water supply line 111a. The first cold water circulation water pump 822 and the second cold water circulation water pump 823 are, for example, cascade pumps.

In addition, a circulation line 824 that returns from the downstream side to the upstream side of the second cold water circulation water pump 823 is disposed in the cold water supply line 111a. A safety valve 825 is disposed in the circulation line 824. The safety valve 825 relieves pressure to prevent pressure increase when the inside of a system of the second cold water circulation water pump 823 and the cold water line 111 reaches a certain pressure or higher. Since the safety valve 825, which relieves pressure when pressure anomaly occurs in the system of the cold water line 111, is disposed in parallel to the second cold water circulation water pump 823, it is possible to achieve both high flow circulation and secure operation of the second cold water circulation water pump 823.

The cold water return line 111b as well is connected in parallel to the reactors 11 and can perform cold water recovery from the reactors 11 after cooling completion in parallel.

The hot water line 112 is a pipe through which hot water as the heating thermal medium flows. The hot water line 112 is branch-connected to the upstream and downstream sides of each reactor 11 to connect the hot water tank 83 and the reactor 11. In the hot water line 112, a line connected to the upstream side of the reactors 11 is referred to as a hot water supply line 112a, and a line connected to the downstream side of the reactors 11 is referred to as a hot water return line 112b.

The hot water supply line 112a is connected in parallel to the reactors 11 and can perform hot water supply to the reactors 11 in parallel. A first hot water circulation water pump 832 and a second hot water circulation water pump 833 are disposed in the hot water supply line 112a. The first hot water circulation water pump 832 and the second hot water circulation water pump 833 are, for example, cascade pumps. When cascade pumps that generate a large amount of heat when driven are used, it is possible to further heat a thermal medium passing through the first hot water circulation water pump 832 and the second hot water circulation water pump 833.

In addition, a circulation line 834 that returns from the downstream side to the upstream side of the second hot water circulation water pump 833 is disposed in the hot water supply line 112a. A safety valve 835 is disposed in the circulation line 834. The safety valve 835 relieves pressure to prevent pressure increase when the inside of a system of the second hot water circulation water pump 833 and the hot water line 112 reaches a certain pressure or higher. Since the safety valve 835, which relieves pressure when pressure anomaly occurs in the system of the hot water line 112, is disposed in parallel to the second hot water circulation water pump 833, it is possible to achieve both high flow circulation and secure operation of the second hot water circulation water pump 833.

The hot water return line 112b as well is connected in parallel to the reactors 11 and can perform hot water recovery from the reactors 11 after heating completion in parallel.

The three-way valves 30 are connected to the cold water line 111, the hot water line 112, and the reactors 11. The three-way valves 30 are disposed on the upstream and downstream sides of each reactor 11. By flow path switching, the three-way valves 30 can select a cold water connection state in which the cold water line 111 is connected to the reactors 11, a hot water connection state in which the hot water line 112 is connected to the reactors 11, and a cutoff state in which connection of the cold water line 111 and the hot water line 112 to the reactors 11 is cut off.

The flow path switching of the three-way valves 30 is controlled by the control device 90. A thermal medium is introduced to each reactor 11 through a three-way valve 30 disposed on the upstream side and is returned to the heat source device 81 side through a three-way valve 30 disposed on the downstream side.

The bypass paths 31 are flow paths that enable thermal medium movement among the reactors 11. Each bypass path 31 connects two reactors 11. The reactors 11 connected by each bypass paths 31 may be adjacent reactors or may be reactors 11 that are not adjacent but separated.

The bypass valves 32 are disposed in the bypass paths 31. The bypass valves 32 are disposed in the respective bypass paths 31. Opening and closing of each bypass valve 32 is controlled by the control device 90.

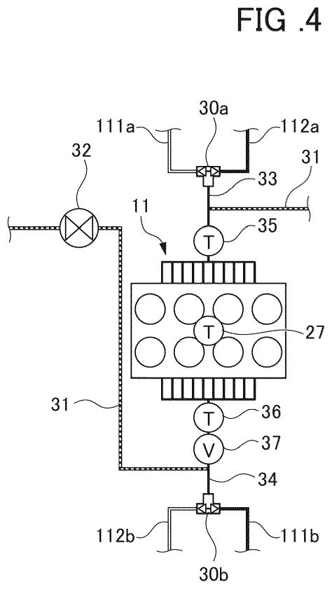

FIG. 4 is a schematic diagram illustrating a configuration related to liquid flow in each reactor 11 of the carbon dioxide recovery device 1 according to the present embodiment. In the following description, a three-way valve 30 disposed upstream of the reactor 11 is referred to as a three-way valve 30a, and a three-way valve 30 disposed downstream of the reactor 11 is referred to as a three-way valve 30b.

As illustrated in FIG. 4, the reactor 11 includes an inlet-side flow path 33 connected to an inlet through which a thermal medium flows in, and an outlet-side flow path 34 connected to an outlet through which the thermal medium flows out. A bypass path 31 is connected to the outlet-side flow path 34 of the reactor 11 and also connected to the inlet-side flow path 33 of another reactor 11.

The three-way valve 30a is disposed at an upstream end part of the inlet-side flow path 33, and the three-way valve 30b is disposed at a downstream end part of the outlet-side flow path 34. In the hot water connection state, the three-way valve 30a is connected to the hot water supply line 112a, and the three-way valve 30b is connected to the hot water return line 112b. In the cold water connection state, the three-way valve 30a is connected to the cold water supply line 111a, and the three-way valve 30b is connected to the cold water return line 111b.

The three-way valve 30a and the three-way valve 30b can adjust flow rate. With this flow rate adjustment function, the flow rate of hot water can be adjusted in the hot water connection state, and the flow rate of cold water can be adjusted in the cold water connection state.

A temperature sensor 35 is disposed in the inlet-side flow path 33. A temperature sensor 36 and a flow rate sensor 37 are disposed in the outlet-side flow path 34. Measurement information of the temperature sensor 35, the temperature sensor 36, and the flow rate sensor 37 is transmitted to the control device 90.

The control device 90 will be described next. The control device 90 controls operation of each component of the carbon dioxide recovery device 1. The control device 90 controls operations such as drive and stop of devices used for carbon dioxide adsorption and desorption. The control device 90 selectively controls the timing of thermal medium supply to each reactor 11 for heating and cooling so that the reactors 11 repeat adsorption and desorption in a time-series manner. The control device 90 controls opening and closing of the first valve 21, the second valve 22, the third valve 23, and the fourth valve 24 included in each reactor 11 and controls opening and closing of each bypass valve 32. In addition, the control device 90 controls drive of the fan 61, the vacuum pump 62, the carbon dioxide recovery pump 63, the first cold water circulation water pump 822, the second cold water circulation water pump 823, the first hot water circulation water pump 832, the second hot water circulation water pump 833, and the like, and controls opening and closing of the safety valve 825 and the safety valve 835.

The control device 90 is, for example, a computer including a central processing unit (CPU), a read only memory (ROM), a random access memory (RAM), and the like. The control device 90 may be configured by one computer or a plurality of computers. Alternatively, the control device 90 may be configured by utilizing an electric circuit such as a relay.

### <Carbon Dioxide Recovery>

Carbon dioxide recovery control by the control device 90 will be described next. The carbon dioxide recovery device 1 removes and recovers carbon dioxide in atmospheric air by alternately performing an adsorption process in which carbon dioxide in a drawn gas such as atmospheric air is adsorbed onto the adsorbent 12 in each reactor 11 and a desorption process in which the carbon dioxide adsorbed onto the adsorbent 12 is desorbed, and storing the desorbed carbon dioxide in the carbon dioxide tank 66.

The adsorption process is a process in which carbon dioxide is adsorbed onto the adsorbent 12 in each reactor 11. In the adsorption process, the third valve 23 and the fourth valve 24 of the reactor 11 are opened and the first valve 21 and the second valve 22 thereof are closed. Along with the valve opening and closing control, the three-way valve 30a and the three-way valve 30b are controlled to the cold water connection state by the heat exchanger 70, and cold water flows inside the reactor 11 and cools the adsorbent 12 in the reactor 11. The fan 61 is driven, gas flow from upstream to downstream occurs, and a gas containing carbon dioxide (for example, atmospheric air) is drawn in through the third valve 23. The drawn gas passes through the adsorbent 12 in the reactor 11. In this process, the inside of the reactor 11 is at room temperature (25° C.) through cooling by cold water, and carbon dioxide in the gas is adsorbed onto the adsorbent 12. Gasses other than carbon dioxide, such as nitrogen and oxygen are exhausted to the outside of the carbon dioxide recovery device 1 through the fourth valve 24 and the adsorption line 101.

The desorption process is a process in which carbon dioxide on the adsorbent 12 in each reactor 11 is desorbed. In the desorption process, the first valve 21, the third valve 23, and the fourth valve 24 of the reactor 11 are closed and the second valve 22 thereof is opened. The vacuum pump 62 operates to draw in gas from the inside of the reactor 11, thereby bringing the inside to a vacuum state or near-vacuum state through depressurization. Along with the valve opening and closing control, the three-way valve 30a and the three-way valve 30b are controlled to the hot water connection state by the heat exchanger 70, and hot water flows through the reactor 11 and supplies thermal energy, thereby increasing the temperature of the adsorbent 12 in the reactor 11. Through the temperature increase control of the adsorbent 12, the adsorbent 12 is heated to a predetermined temperature (for example, 80° C.) that is sufficient for the desorption process, and carbon dioxide adsorbed onto the adsorbent 12 is desorbed. Subsequently, the second valve 22, the third valve 23, and the fourth valve 24 are closed and the first valve 21 is opened, and then the carbon dioxide recovery pump 63 is driven to store the desorbed carbon dioxide in the carbon dioxide tank 66 through the carbon dioxide line 103. In the present embodiment, processes are controlled so that, among the 16 reactors 11, 12 reactors 11 execute the adsorption process and the remaining four reactors perform the desorption process.

### <Heat Source Circuit>

A detailed configuration of the heat source circuit 80 will be described next with reference to FIG. 5. FIG. 5 is a schematic diagram illustrating the configuration of the heat source circuit 80 of the carbon dioxide recovery device 1 according to the present embodiment.

As illustrated in FIG. 5, the heat source circuit 80 according to the present embodiment includes the heat source device 81, a heat source high-temperature water circuit 85 including the hot water tank 83, a heat source low-temperature water circuit 86 including the cold water tank 82, and an instrument heat recovery circuit 87.

The heat source device 81 cools a thermal medium introduced from the cold water tank 82 and heats a thermal medium introduced from the hot water tank 83. The heat source device 81 is constituted by a heat pump that transfers heat by utilizing gas compression and expansion.

The heat source high-temperature water circuit 85 circulates hot water between the hot water tank 83 and the heat source device 81. The heat source high-temperature water circuit 85 includes the hot water tank 83, a hot water side heat source supply line 221, and a hot water side heat source return line 222.

The hot water tank 83 is a thermal storage device having a heat-insulating function and capable of accumulating a thermal medium. The capacity of the hot water tank 83 is preferably set to be at least five times the maximum discharge flow rate of a hot water side circulation water pump 831 to be described later. By setting the capacity of the hot water tank 83 to be large relative to the flow rate of the thermal medium, it is possible to suppress water temperature fluctuations of the hot water (thermal medium) during thermal load fluctuations within a predetermined temperature range (for example, +5° C. or less). Accordingly, the hot water tank 83 functions as a thermal load fluctuation buffer.

The hot water tank 83 is connected to the heat source device 81 through the hot water side heat source supply line 221 and the hot water side heat source return line 222. The hot water tank 83 is also connected to the hot water supply line 112a and the hot water return line 112b.

The hot water side heat source supply line 221 is a path through which the thermal medium flows from the hot water tank 83 to the heat source device 81. The hot water side circulation water pump 831 is disposed in the hot water side heat source supply line 221. The hot water side circulation water pump 831 is constituted by, for example, a centrifugal pump and circulates the thermal medium between the hot water tank 83 and the heat source device 81. The hot water side heat source return line 222 is a path through which the thermal medium flows from the heat source device 81 to the hot water tank 83.

The heat source low-temperature water circuit 86 will be described next. The heat source low-temperature water circuit 86 circulates cold water between the cold water tank 82 and the heat source device 81. The heat source low-temperature water circuit 86 includes the cold water tank 82, a cold water side heat source supply line 121, a cold water side heat source return line 122, and the instrument heat recovery circuit 87.

The cold water tank 82 is a thermal storage device having a heat-insulating function and capable of accumulating a thermal medium. The capacity of the cold water tank 82 is preferably set to be at least five times the maximum discharge flow rate of a cold water side circulation water pump 821 to be described later. By setting the capacity of the cold water tank 82 to be large relative to the flow rate of the thermal medium, it is possible to suppress water temperature fluctuations of the cold water (thermal medium) during thermal load fluctuations within a predetermined temperature range (for example, +5° C. or less). Accordingly, the cold water tank 82 functions as a thermal load fluctuation buffer.

The cold water tank 82 is connected to the heat source device 81 through the cold water side heat source supply line 121 and the cold water side heat source return line 122. The cold water tank 82 is also connected the cold water supply line 111a and the cold water return line 111b.

The cold water side heat source supply line 121 is a path through which the thermal medium flows from the cold water tank 82 to the heat source device 81. The cold water side circulation water pump 821 is disposed in the cold water side heat source supply line 121. The cold water side circulation water pump 821 is constituted by, for example, a centrifugal pump and circulates the thermal medium between the cold water tank 82 and the heat source device 81. The cold water side heat source return line 122 is a path through which the thermal medium flows from the heat source device 81 to the cold water tank 82.

The instrument heat recovery circuit 87 will be described next. The instrument heat recovery circuit 87 cools target instruments such as the carbon dioxide recovery pump 63 and the heat exchanger 64 and increases the temperature of the thermal medium. The instrument heat recovery circuit 87 is connected in parallel to the heat source low-temperature water circuit 86.

The instrument heat recovery circuit 87 according to the present embodiment includes an instrument heat cooling line 126 that has an upstream end part connected to the cold water side heat source return line 122 and has a downstream end part connected to the cold water side heat source supply line 121. The instrument heat cooling line 126 includes a first branch line 126a that cools the carbon dioxide recovery pump 63 and a second branch line 126b that cools the heat exchanger 64.

The first branch line 126a is connected to the carbon dioxide recovery pump 63 and cools the carbon dioxide recovery pump 63 by using cold water as the thermal medium. In the state of being heated through heat exchange with the carbon dioxide recovery pump 63, the cold water merges into the second branch line 126b and is transferred to the cold water side heat source supply line 121.

The second branch line 126b is connected to the heat exchanger 64 that generates water vapor condensation heat, and cools the heat exchanger 64 by using cold water as the thermal medium to recover waste heat from the water vapor condensation heat. In the state of being heated through heat exchange with the heat exchanger 64, the cold water merges into the first branch line 126a and is transferred to the cold water side heat source supply line 121.

As described above, the instrument heat recovery circuit 87 can recover waste heat of the vacuum pump 62 and the carbon dioxide recovery pump 63 to the thermal medium, thereby cooling the target instruments, and also allow the thermal medium to flow into the heat source device 81 with a high temperature potential because of the heat recovery. Since the temperature of cold water is increased to a predetermined temperature or higher, the temperature difference between hot water and cold water flowing into the heat source device 81 decreases, thereby improving COP.

### <Ballast Gas Introduction to Carbon Dioxide Recovery Pump>

A connection structure of the carbon dioxide recovery pump 63, the heat exchanger 64, and the separator 65 according to the present embodiment will be described below with reference to FIG. 6. FIG. 6 is a schematic diagram illustrating a configuration for introducing ballast gas with high carbon dioxide concentration into the carbon dioxide recovery pump 63 in the carbon dioxide recovery device 1 according to the present embodiment.

The carbon dioxide recovery pump 63 illustrated in FIG. 6 is a vacuum pump that compresses a high-temperature gas containing carbon dioxide and superheated water vapor back to atmospheric pressure.

The carbon dioxide recovery pump 63 according to the present embodiment includes a compression chamber 151 that executes a compression process in which a high-temperature gas is compressed through rotation of a screw 152, a bearing 153 that pivotally supports the screw 152, and a gear box 154 disposed on a side opposite the compression chamber 151 with the bearing 153 in between.

A high-temperature gas containing carbon dioxide desorbed from the adsorbent 12 in each reactor 11 and superheated water vapor flows into the compression chamber 151 of the carbon dioxide recovery pump 63 through the carbon dioxide line 103, is compressed back to atmospheric pressure in the compression chamber 151, and then is sent out to the heat exchanger 64 through an exhaust port 155.

The heat exchanger 64 is connected to the exhaust port 155 of the carbon dioxide recovery pump 63. A flow path 160 through which the high-temperature gas containing carbon dioxide and superheated water vapor, which is sent from the carbon dioxide recovery pump 63, flows is formed inside the heat exchanger 64. The flow path 160 is sloped so that an inlet 160a side is positioned higher and an outlet 160b side is positioned lower. A pipe 161 is connected to the outlet 160b of the flow path 160 in the heat exchanger 64.

Cold water is introduced into the heat exchanger 64 as a cooling thermal medium that cools the high-temperature gas. The cold water introduced into the heat exchanger 64 flows outside the flow path 160 while performing heat exchange with the high-temperature gas flowing inside the flow path 160. Through the heat exchange between the cold water and the high-temperature gas, the superheated water vapor included in the high-temperature gas becomes supercooled liquid. On the other hand, the temperature of the cold water, which serves as the counterpart of the heat exchange, is increased. As described above, the cold water is a cooling thermal medium flowing through the instrument heat recovery circuit 87, and thermal energy obtained by cooling the high-temperature gas is used to increase the temperature of the cold water flowing into the heat source device 81.

The pipe 161 has an upstream end part connected to the outlet 160b of the flow path 160 in the heat exchanger 64, and branches toward the separator 65 and the carbon dioxide tank 66 on the downstream side. In the following description, in the pipe 161, a pipe connected to the separator 65 side is referred to as a separator side pipe 161a, and a pipe connected to the carbon dioxide tank 66 side is referred to as a carbon dioxide side pipe 161b.

The separator side pipe 161a is connected to the separator 65 positioned lower than the outlet 160b of the flow path 160 in the heat exchanger 64. The separator 65 is a catch tank that accumulates water obtained through cooling from superheated water vapor to liquid by the heat exchanger 64.

The carbon dioxide side pipe 161b is connected to the carbon dioxide tank 66. A gas containing, as a primary component, carbon dioxide from which moisture is removed through gas-liquid separation in the heat exchanger 64 flows into the carbon dioxide side pipe 161b. The carbon dioxide side pipe 161b according to the present embodiment is connected to the ballast pipe 170 connected to the upstream side of the heat exchanger 64.

The ballast pipe 170 is a ballast gas flow path through which a gas having a high carbon dioxide concentration and flowing through the carbon dioxide side pipe 161b is sent as ballast gas into the carbon dioxide recovery pump 63 positioned upstream of the heat exchanger 64. A compressor 171 for sending the ballast gas from the carbon dioxide side pipe 161b into the carbon dioxide recovery pump 63 under pressure is disposed in the ballast pipe 170. The compressor 171 is connected to, for example, the control device 90 and driven based on signals from the control device 90. The compressor 171 may have a function to be activated by an activation switch included in the compressor 171.

The ballast pipe 170 has an upstream end part connected halfway through the carbon dioxide side pipe 161b before reaching the carbon dioxide tank 66. The ballast pipe 170 has a downstream end part connected to a downstream part of the compression chamber 151 inside the carbon dioxide recovery pump 63. In the present embodiment, the downstream end part of the ballast pipe 170 is connected to the bearing 153 part positioned on the furthest downstream side in the compression chamber 151, and the ballast gas is introduced into the carbon dioxide recovery pump 63 to seal the gear box 154.

Although the configuration in which the upstream end part of the ballast pipe 170 is connected to the carbon dioxide side pipe 161b is described above in the embodiment, the present invention is not limited to the configuration. For example, the upstream end part of the ballast pipe 170 may be connected to the carbon dioxide tank 66 so that a gas with high carbon dioxide concentration, which is accumulated in the carbon dioxide tank 66 is returned to the carbon dioxide recovery pump 63 as ballast gas.

Although the configuration in which the downstream end part of the ballast pipe 170 is connected to the downstream side of the compression chamber 151 in the carbon dioxide recovery pump 63 is described above in the embodiment, the present invention is not limited to the configuration. For example, the downstream end part of the ballast pipe 170 may be disposed on the upstream side of the compression chamber 151 or may be disposed in a flow path connected to the downstream side of the compression chamber 151 before reaching the exhaust port 155. In this manner, ballast gas containing carbon dioxide as a primary component is preferably introduced at or after a position where a high-temperature gas returns to atmospheric pressure in the compression process.

Although the thermal medium introduced into the heat exchanger 64 is cold water of the heat source low-temperature water circuit 86 in the above-described embodiment, the present invention is not limited to this configuration. For example, hot water of the heat source high-temperature water circuit 85 may be introduced into the heat exchanger 64 as the thermal medium.

As described above, the carbon dioxide recovery device 1 according to the present embodiment includes a reactor 11 that includes the adsorbent 12 inside and executes the adsorption process in which a gas containing carbon dioxide is drawn toward the adsorbent 12 to adsorb the carbon dioxide and the desorption process in which the adsorbent 12 is heated under surrounding reduced pressure to desorb the carbon dioxide from the adsorbent 12, the carbon dioxide recovery pump 63 that applies suction force inside the reactor 11 to recover the carbon dioxide desorbed in the desorption process, the heat exchanger (cooler) 64 that is disposed downstream of the carbon dioxide recovery pump 63 and cools a gas containing the carbon dioxide drawn by the carbon dioxide recovery pump 63 and water vapor to perform gas-liquid separation, and the ballast pipe 170 that returns at least part of the carbon dioxide after gas-liquid separation through the heat exchanger 64 into the carbon dioxide recovery pump 63 as ballast gas.

With this configuration, the ballast gas with high carbon dioxide concentration is sent into the carbon dioxide recovery pump 63, which decreases vapor pressure inside the carbon dioxide recovery pump 63 so that water is unlikely to condense. Accordingly, water condenses in postprocessing and the timing of water liquefaction can be controlled to the downstream side as compared to a case where no ballast gas is sent. Moreover, the ballast gas is a gas containing carbon dioxide as a primary component unlike other gasses such as nitrogen and dry air, and thus the concentration of carbon dioxide recovered in the carbon dioxide tank 66 on the downstream side is not lowered.

In the present embodiment, the carbon dioxide recovery pump 63 includes the compression chamber 151 that executes the compression process in which the gas drawn from the reactor 11 is returned to atmospheric pressure, and the ballast pipe 170 is connected to or downstream of the compression chamber 151 inside the carbon dioxide recovery pump 63.

With this configuration, water generation due to water vapor condensation in the compression process can be effectively prevented by the ballast gas without lowering the carbon dioxide concentration on the downstream side.

In the present embodiment, the flow path 160 through which the gas passes in the heat exchanger 64 is sloped so that the outlet 160b is positioned lower than the inlet 160a.

With this configuration, water cooled to liquid by the heat exchanger 64 flows to the separator 65 on the downstream side along the slope without staying in place, which can further reduce the possibility of decrease in the concentration of recovered carbon dioxide due to mixture of the water and carbon dioxide.

The carbon dioxide recovery device 1 according to the present embodiment further includes the heat-pump heat source device 81 that heats a heating thermal medium supplied to the reactor 11 and cools a cooling thermal medium supplied to the reactor, and a thermal medium that cools the heat exchanger 64 is cold water (cooling thermal medium) or hot water (heating thermal medium).

With this configuration, it is possible to suppress decrease in the carbon dioxide concentration due to contamination that water mixes with carbon dioxide, and recover condensation heat of high-temperature gas in the heat exchanger 64 and waste heat during cooling, in parallel, and thus the heat source device 81 can be efficiently operated.

Although the embodiment of the present invention is described above, the present invention is not limited to the above-described embodiment and modification. Moreover, the effects described in the above embodiment are merely examples of preferable effects, and the present invention is not limited to those described in the above embodiment.

### EXPLANATION OF REFERENCE NUMERALS

1 carbon dioxide recovery device
11 reactor
12 adsorbent
62 vacuum pump
63 carbon dioxide recovery pump
64 heat exchanger (cooler)
65 separator
70 heat exchanger
80 heat source circuit
81 heat source device
85 heat source high-temperature water circuit
86 heat source low-temperature water circuit
87 instrument heat recovery circuit
151 compression chamber
160 flow path
170 ballast pipe

What is claimed is:

1. A carbon dioxide recovery device comprising:
a reactor that includes an adsorbent inside and executes an adsorption process in which a gas containing carbon dioxide is drawn toward the adsorbent to adsorb the carbon dioxide and a desorption process in which the adsorbent is heated under surrounding reduced pressure to desorb the carbon dioxide from the adsorbent;
a carbon dioxide recovery pump that applies suction force inside the reactor to recover the carbon dioxide desorbed in the desorption process;
a cooler that is disposed downstream of the carbon dioxide recovery pump and cools a gas containing the carbon dioxide drawn by the carbon dioxide recovery pump and water vapor to perform gas-liquid separation; and
a ballast pipe that returns at least part of the carbon dioxide after gas-liquid separation through the cooler into the carbon dioxide recovery pump as ballast gas.

2. The carbon dioxide recovery device according to claim 1, wherein
the carbon dioxide recovery pump includes a compression chamber that executes a compression process in which the gas drawn from the reactor is returned to atmospheric pressure, and
the ballast pipe is connected to or downstream of the compression chamber inside the carbon dioxide recovery pump.

3. The carbon dioxide recovery device according to claim 1, wherein a flow path through which the gas passes in the cooler is sloped so that an outlet is positioned lower than an inlet.

4. The carbon dioxide recovery device according to claim 1, further comprising a heat-pump heat source device that heats a heating thermal medium supplied to the reactor and cools a cooling thermal medium supplied to the reactor,
wherein a thermal medium that cools the cooler is the cooling thermal medium or the heating thermal medium.
